(19) United States
(12) Patent Application Publication
(10) Pub. No.: US 2021/0389061 A1
(43) Pub. Date: Dec. 16, 2021

(54) HEAT EXCHANGE APPARATUS AND METHOD

(71) Applicant: UT-BATTELLE, LLC, OAK RIDGE, TN (US)

(72) Inventor: Kashif Nawaz, Knoxville, TN (US)

(21) Appl. No.: 17/343,277

(22) Filed: Jun. 9, 2021

Related U.S. Application Data
(60) Provisional application No. 63/037,629, filed on Jun. 11, 2020.

(51) Int. Cl. F28F 13/00; F28F 13/02; F28F 21/08

(52) U.S. Cl. CPC F28F 13/003; F28F 13/02; F28F 21/089; F28F 21/085; F28F 21/084; F28F 21/082

(57) ABSTRACT

A heat exchanger apparatus includes a tube having a wall with an inner surface and an outer surface. The tube is configured to receive heat exchange fluid at one end, and output, when heated through the wall, vapor of the heat exchange fluid at the opposing end. A first layer of thermally conductive porous material is disposed on the inner surface of the tube. Heating equipment, a heat exchanger, and a method of heating are also disclosed.

### CROSS-REFERENCE TO RELATED APPLICATIONS

This application claims priority to U.S. 63/037,629 filed on Jun. 11, 2020, entitled “Natural Gas-Fired Boiler for Residential and Light Commercial Applications”, the entire disclosure of which incorporated herein by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in this invention.

### FIELD OF THE INVENTION

The present invention relates to heat exchange methods and devices, and more particularly to flow boiling heat exchange devices and methods.

### BACKGROUND OF THE INVENTION

Flow boiling is a heat exchange process in which a liquid flows through a heat exchange tube or conduit, and absorbs heat flowing through the tube. As the liquid absorbs heat that is transferred through the wall of the tube and saturation conditions are reached, the process of nucleation starts, and the formation of vapor bubbles is initiated. Following this process along the heated tube, the void fraction (gas flow cross-sectional area divided by the total cross-sectional area) increases and the flow transitions through a sequence of flow regimes. These flow regimes begin with a single-phase liquid flow to bubbly flow and plug flow, where a nucleate boiling-dominated regime exists, to an annular film flow evaporation dominated regime, to finally single-phase vapor flow where nucleate boiling is suppressed. Each flow pattern has distinct thermo-hydraulic features and, based on how the vapor/liquid phases are distributed along the flow path, these flow patterns can significantly impact the associated pressure drop and heat transfer rate. Since liquid has better thermo-physical characteristics than vapor (greater thermal conductivity, heat capacity and density), it is always preferred to maintain the liquid phase adjacent to the tube wall and the vapor phase within the core. A relatively higher value of heat transfer coefficient is associated with the annular flow regime. If the fluid is not properly distributed, underutilization of the surface area will result.

### SUMMARY OF THE INVENTION

A heat exchanger apparatus can include a tube having a wall with an inner surface and an outer surface. The tube can be configured to receive heat exchange fluid at one end, and output, when heated through the wall, vapor of the heat exchange fluid at the opposing end. A first layer of thermally conductive porous material can be disposed on the inner surface and/or the outer surface.

The heat exchange fluid can include water, and the vapor of the heat exchange fluid is steam. The thermally conductive porous material can be at least one selected from the group consisting of Cu, Al, or Fe, and alloys thereof.

The thermally conductive porous material can include foams such as metal foams. The foams can comprise open cells. The open cells can have pore openings between cells, and the pore size of the pore openings can be from 0.1 μm to 10 mm. The metal foam can have a porosity in a range of 40%-95%. The metal foam can have a pore density in a range of 5-100 pores per inch (PPI). The open cells can have a cell diameter of from 1 μm to 10 mm.

The cell diameter of the open cells can increase from a first size proximate to the wall to a second size greater than the first size distal to the wall. The tube has a flow direction, and the cell diameter of the open cells can increase from a first size at an upstream location relative to the flow direction to a second size greater than the first size downstream relative to the flow direction. The metal foam has a layer thickness, and the layer thickness the metal foam can increase from a first size at an upstream location relative to the flow direction to a second size greater than the first size downstream relative to the flow direction.

The heat exchanger can include a first layer of thermally conductive porous material that has a thickness in a range of 0.5%-50% of the inner radius of the tube. The heat exchanger can further include a second layer of thermally conductive porous metal on the outer surface. The second layer of thermally conductive porous material can have a thickness in a range of 10%-100% of the outer radius of the tube or 10%-50% of the distance between adjacent portions of the tube, when the tube is configured to have one or more bends.

The heat exchanger can further include a ceramic coating on at least one selected from the group consisting of the first layer of thermally conductive porous material and the second layer of thermally conductive porous material. The ceramic coating can comprise SiC or SiN, or other suitable materials.

Heating equipment according to the invention can include a burner and a heat exchanger comprising a tube having a wall with an inner surface and an outer surface. The tube is configured to receive heat exchange fluid at one end, and output, when heated through the wall, vapor of the heat exchange fluid at the opposing end. A first layer of thermally conductive porous material disposed on the inner surface. The tube of the heat exchanger is disposed adjacent to the burner, so the heat exchange fluid is heated through the wall by the burner during operation of the heating equipment.

The heat exchanger can be configured as a boiler or an evaporator. The heat exchanger can be a flow boiler. The burner can be configured to be fueled with natural gas.

A heat exchanger according to the invention can include a tube having a wall with an inner surface and an outer surface. The tube can be configured to receive heat exchange fluid at one end, and output, when heated through the wall, vapor of the heat exchange fluid at the opposing end. A first layer of thermally conductive porous metal foam can be disposed on the inner surface. A second layer of the thermally conductive porous metal foam can be disposed on the outer surface.

A heat exchanger can include a heat exchange wall with a first surface and a second surface for separating a first heat exchange fluid from a second heat exchange fluid. The first fluid moves in a flow direction relative to the first surface of the wall. A first layer of thermally conductive porous open cell metal foam is disposed on the first surface, the open cells of the metal foam having a cell diameter. The cell diameter of the open cells increases from a first size proximate to the wall to a second size greater than the first size distal to the wall. The cell diameter of the open cells increases from a first size at an upstream location relative to the flow direction to a second size greater than the first size downstream relative to the flow direction. The first fluid flows through the open cells of the metal foam in the flow direction, and changes state from a liquid to a gas, and the gas passes through cells having a greater cell diameter than the cell diameter of the cells through which the liquid flows.

A method of heating a fluid includes the step of providing a heat exchange tube comprising a heat exchange wall with a first surface and a second surface for separating a first heat exchange fluid from a second heat exchange fluid. The first fluid moves in a flow direction relative to the first surface of the wall, with a first layer of thermally conductive porous material disposed on the first surface. The first fluid is flowed through the thermally conductive porous material in the flow direction, wherein the first heat exchange fluid exchanges heat with the second heat exchange fluid.

The porous material can comprise open cells having a cell diameter, and wherein the cell diameter of the open cells increases from a first size proximate to the wall to a second size greater than the first size distal to the wall. The porous material can comprise open cells having a cell diameter, and the cell diameter of the open cells increases from a first size at an upstream location relative to the flow direction to a second size greater than the first size downstream relative to the flow direction.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a schematic cross-sectional diagram of a heat exchange tube according to the invention undergoing flow boiling.

FIG. 2 is a cross-section taken along line 2-2 in FIG. 1.

FIG. 3 is a cross-section taken along line 3-3 in FIG. 1.

FIG. 4 is a cross-section taken along line 4-4 FIG. 1.

FIG. 5 is a cross-section taken along line 5-5 FIG. 1.

FIG. 6 is a magnified cross section of a heat exchange foam according to the invention.

FIG. 7 is a magnified schematic view of area FIG. 7 in FIG. 6.

FIG. 8 is a schematic cross-section of a flow boiler heat exchange apparatus.

FIG. 9 is a longitudinal cross-section of a heat exchange tube having a heat exchange foam layer on an inside surface of the heat exchange tube and a heat exchange foam on an outside surface of the tube.

FIG. 10 is a lateral cross section.

FIG. 11 is a schematic cross-section of a volumetric matrix combustion (VMC) heat exchanger according to the invention.

FIG. 12 is a cross-section of a heat exchange tube having a radial gradient cell size heat exchange foam layer.

FIG. 12A is a magnified view of area 12A in FIG. 12; FIG. 12B is a magnified view of area 12B in FIG. 12; and FIG. 12C is a magnified view of area 12C in FIG. 12.

FIG. 13 is a cross-section of a heat exchange tube having a radial and longitudinal gradient cell size heat exchange foam layer.

FIG. 13A is a magnified view of area 13A in FIG. 13; FIG. 13B is a magnified view of area 13B in FIG. 13; FIG. 13C is a magnified view of area 13C in FIG. 13; FIG. 13D is a magnified view of area 13D in FIG. 13; FIG. 13E is a magnified view of area 13E in FIG. 13; and FIG. 13F is a magnified view of area 13F in FIG. 13.

FIG. 14 is an enlarged schematic diagram of area FIG. 14 in FIG. 13.

### DETAILED DESCRIPTION OF THE INVENTION

A heat exchanger includes a tube having a wall with an inner surface and an outer surface. The tube is configured to receive heat exchange fluid at one end, and output, when heated through the wall, vapor of the heat exchange fluid at the opposing end. A first layer of thermally conductive porous material is disposed on the inner surface of the tube.

The heat exchange fluid can be selected from many possible fluids. One such fluid is water, and the vapor of the heat exchange fluid can be steam. Other fluids can include hydrocarbons, refrigerants, oils and molten salts.

The thermally conductive porous material should have interconnected pores which permit fluid flow in at least two directions, and possibly three. Various open cell architectures are possible. Open cell foams in particular are desirable because should foams are readily formed and have both desirable flow characteristics and heat conduction. Different foam materials are possible. The foam material can include at least one selected from the group consisting of Cu, Al, or Fe, and alloys thereof. The material making up the foam can include ceramics such as SiC and alumina. Other materials such as carbon foams, ceramics and high entropy (temperature) alloys, polymer and polymer composites can be utilized. Methods of making such foams are known and any such method is possible. The foams can be manufactured on the surface of the tube wall or deployed as a layer by a brazing process. The gradient in the foam structure can be achieved by any suitable manufacturing process capable of making cells and pores with different sizes, such as additive manufacturing or by post-processing such as by selective compression.

Cell size and the pore size between cells is important parameter because smaller cells limit the size of vapor bubbles, which decreases the residence time of the bubbles and promotes vapor flow and removal, enhancing heat transfer. Essentially, the foam cells act like containers that do not allow the vapor bubbles to grow beyond the size of the cell. The cell size also can affect the number of nucleation sites for vaporization. A smaller cell size will provide more nucleation sites per unit volume of the porous foam. The nucleation sites are three dimensional, and the seams between pore cells of the foam serve as nucleation sites. Also, the ends of cell walls forming pore openings can serve as nucleation sites.

A smaller cell size promotes liquid wicking, and a larger cell size promotes vapor flow. The cell size can form a gradient to promote liquid wicking at one part of the foam, usually near the tube wall, while larger cells away from the tube wall can be provided to facilitate vapor flow as the liquid absorbs heat and turns into a vapor. Generally, the cell size, and the pore size between cells, can increase in the direction of increasing vapor formation and travel, whereby the larger cell size will accommodate the greater volume of the gas that is formed as the fluid moves down the tube and increasingly vaporizes. The pore size can increase radially inward as vapor will accumulate in the center of the tube as it move down the tube. The cell and pore size can also increase in the axial flow direction to accommodate the greater vapor formation as the liquid flows down the tube and becomes vaporized. A smaller cell and pore size near the wall helps to wick the liquid. Also, the thickness of the metal foam layer can increase in the axial direction to also accommodate the growing amount of vapor formation as the fluid proceeds down the tube and the increasing size of the cells.

The foam layer can be provided on an inside surface of the tube, and outside surface of the tube, or both. The foam layer if also on the outside of the tube can have the same or different dimensions as the foam on the inside of the tube.

The thermally conductive porous material can further comprise a ceramic layer coating on at least one selected from the group consisting of the first layer of thermally conductive porous material and the second layer of thermally conductive porous material. The ceramic layer can comprise SiC or SiN. Other ceramic coating materials, or combinations of materials, are possible. The coating can protect the underlying foam materials from degradation by the fluid. The coating can also be applied disproportionately across an underlying foam substructure to create or help to create a cell size and pore size gradient.

The specific surface area and thermal conductivity of the foam facilitate heat transfer to the liquid. The open cell foam provides a very high surface area per unit volume of from 500-10000 m²/m³. The surface area per unit volume of the foam can be 500, 1000, 1500, 2000, 2500, 3000, 3500, 4000, 4500, 5000, 5500, 6000, 6500, 7000, 7500, 8000, 8500, 9000, 9500, or 10000 m²/m³, and can be within a range of any high value and low value selected from these values. The foam can have a thermal conductivity of between 1 W/m-K to 1000 W/m-K. The thermal conductivity of carbon fiber based foams can for example be much higher than metal such as aluminum and copper. The foam can have a thermal conductivity of 1, 50, 100, 150, 200, 250, 300, 350, 400, 450, 500, 550, 600, 650, 700, 750, 800, 850, 900, 950, or 1000 W/m-K, and can be within a range of any high value and low value selected from these values.

The metal foam can have a porosity in a range of 40%-95%. The metal foam can have a porosity of 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 7, 77, 78, 79, 80, 81, 82, 83, 84, 85, 86, 87, 88, 89, 90, 91, 92, 93, 94, or 95%, and can be within a range of any high value and low value selected from these values.

The metal foam can have a pore density in a range of 5-100 pores per inch (PPI). The pore density can be 5, 10, 15, 20, 25, 30, 35, 40, 45, 50, 55, 60, 65, 70, 75, 80, 85, 90, 95 or 100 PPI, or can be within a range of any high value and low value selected from these values.

The open cells have pore openings between cells. The pore size of the pore openings can be from 0.1 micron to 10 mm. The pore size of the pore openings can be 0.0001, 0.0002, 0.0003, 0.0004, 0.0005, 0.0006, 0.0007, 0.0008, 0.0009, 0.001, 0.005, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, 5, 5.5 6, 6.5, 7, 7.5, 8, 8.5, 9, 9.5 or 10 mm, or can be within a range of any high value and low value selected from these values.

The open cells have a cell diameter of from 1 micron to 10 mm. The open cells can have a cell diameter of 0.001, 0.005, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, 5, 5.5 6, 6.5, 7, 7.5, 8, 8.5, 9, 9.5 or 10 mm, or can be within a range of any high value and low value selected from these values.

The layer of thermally conductive porous material can have a thickness in a range of 0.5%-50% of the inner radius of the tube. The first layer of thermally conductive porous material can have a thickness that is 0.5, 1, 2, 3, 4, 5, 6, 7, 8, 9, 10, 11, 12, 13, 14, 15, 16, 17, 18, 19, 20, 21, 2, 23, 24, 25, 26, 27, 28, 29, 30, 31, 32, 33, 34, 35, 36, 37, 38, 39, 40, 41, 42, 43, 44, 45, 46, 47, 48, 49, or 50% of the inner radius of the tube, or can be within a range of any high value and low value selected from these values.

The cell diameter of the open cells can increase from a first size proximate to the wall to a second size greater than the first size distal to the wall. The largest cell can be 1.1× to 1000× larger compared to the smallest cell. The largest cell can be 1.1, 2, 3, 4, 5, 6, 7, 8, 9, 10, 50, 100, 150, 200, 250, 300, 350, 400, 450, 500, 550, 600, 650, 700, 750, 800, 850, 900, 950, or 1000 times larger than the smallest cell, or can be within a range of any high value and low value selected from these values.

The tube has a flow direction. The cell diameter of the open cells can increase from a first size at an upstream location relative to the flow direction to a second size greater than the first size downstream relative to the flow direction. The largest cell in a downstream location relative to an upstream cell in the same radial position can be 1.1× to 1000× larger compared to the smallest upstream cell. The largest cell can be 1.1, 2, 3, 4, 5, 6, 7, 8, 9, 10, 50, 100, 150, 200, 250, 300, 350, 400, 450, 500, 550, 600, 650, 700, 750, 800, 850, 900, 950, or 1000 times larger than the smallest cell, or can be within a range of any high value and low value selected from these values.

The metal foam has a layer thickness. The layer thickness the metal foam can increase from a first size at an upstream location relative to the flow direction to a second size greater than the first size downstream relative to the flow direction.

A second layer of thermally conductive porous metal can be provided on the outer surface of the tube. The second layer of thermally conductive porous material can have a thickness in a range of 10%-100% of the outer radius of the tube or 10%-50% of the distance between adjacent portions of the tube, when the tube is configured to have one or more bends.

The heat exchanger as shown in embodiments herein as a tube with a tubular configuration. The term tube as used herein refers to a heat exchange fluid conduit. Other shapes and configurations are possible aside from a strictly tubular shape, for example, rectangles, plates, and annular or coaxial arrangements. Further, varying dimensions are possible. The tube size can vary from ˜1 mm to 1000 mm, and can in some applications be larger or smaller. The shape can vary from perfect circular cross-section to various ovel configuration and elliptical profiles such as tear-shapes and air foils cross-sections.

The invention can be used for different types of heat exchangers, including but not limited to flow boiling heat exchangers. The invention is also useful for boilers, condensers, evaporators, recuperators, energy recovery devices, energy storage devices, heat pipes, vapor chambers, solar receiver, reactors, and other types of devices.

Heating equipment according to the invention can include a heat exchanger with a heat exchange tube and a burner. The tube of the heat exchanger is disposed adjacent to the burner, so the heat exchange fluid is heated through the wall by the burner during operation of the heating equipment. The heating equipment can be configured as a boiler or an evaporator. The heat exchanger can be a flow boiler. The burner can be configured to be fueled with natural gas. Other type of heating devices include air heaters, oil heaters, steam generators, heat pipes, and vapor chambers.

A heat exchanger according to another embodiment of the invention can include a tube having a wall with an inner surface and an outer surface. The tube is configured to receive heat exchange fluid at one end, and output, when heated through the wall, vapor of the heat exchange fluid at the opposing end. A first layer of thermally conductive porous metal foam is disposed on the inner surface. A second layer of the thermally conductive porous metal foam is disposed on the outer surface.

A heat exchanger can include a heat exchange wall with a first surface and a second surface for separating a first heat exchange fluid from a second heat exchange fluid, the first fluid moving in a flow direction relative to the first surface of the wall. A first layer of thermally conductive porous open cell metal foam is disposed on the first surface. The open cells of the metal foam have a cell diameter. The cell diameter of the open cells increases from a first size proximate to the wall to a second size greater than the first size distal to the wall. The cell diameter of the open cells increases from a first size at an upstream location relative to the flow direction to a second size greater than the first size downstream relative to the flow direction. The first fluid flows through the open cells of the metal foam in the flow direction, and changes state from a liquid to a gas. The gas thereby passes through cells having a greater cell diameter than the cell diameter of the cells through which the liquid flows.

A method of heating a fluid can include the steps of providing a heat exchanger comprising a heat exchange wall with a first surface and a second surface for separating a first heat exchange fluid from a second heat exchange fluid, the first fluid moving in a flow direction relative to the first surface of the wall. A first layer of thermally conductive porous material such as an open cell metal foam can be disposed on the first surface. The open cells of the metal foam can have a cell diameter, and the cell diameter of the open cells can increase from a first size proximate to the wall to a second size greater than the first size distal to the wall. The first fluid is flowed through the open cells of the metal foam in the flow direction, wherein the first fluid is heated and changes state from a liquid to a gas, and wherein the first fluid in the liquid state passes through cells having the first size cell diameter, and the first fluid in the gaseous state passes through cells having the second size greater than the first size. The cell diameter of the open cells can increase from a first size at an upstream location relative to the flow direction to a second size greater than the first size downstream relative to the flow direction.

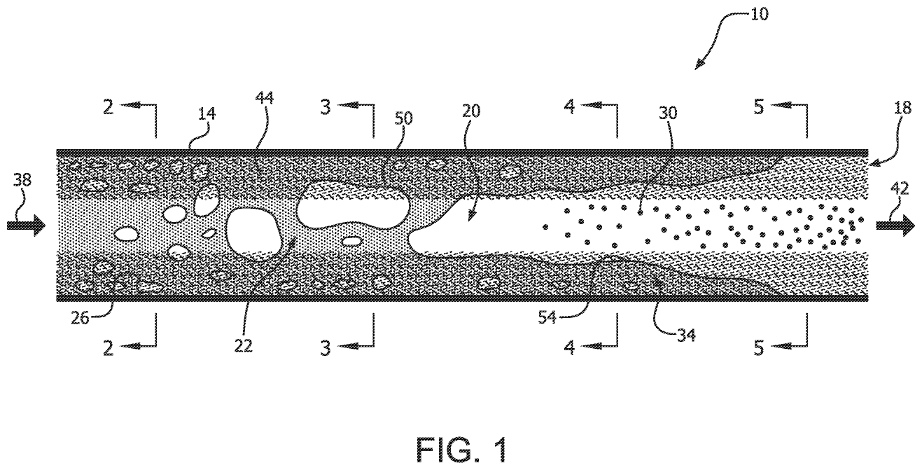

There is shown in FIG. 1 a heat exchange tube 10 according to the invention with a tube wall 14 and a thermally conductive porous material layer such as open cell metal foam layer 18 extending radially inward from the tube wall 14. The open cell foam layer 18 is tubular-shaped and provides an open center 20. Liquid flow is generally in the direction from a flow inlet 38 and flow outlet 42. As the liquid 22 absorbs heat it begins to boil and form small bubbles 26. As the liquid proceeds down the tube 10 the liquid evaporates into vapor particles 30. The vapor particles 30 flow to the open center 20 and unevaporated liquid remains at the tube wall 14, forming an annular flow region 34.

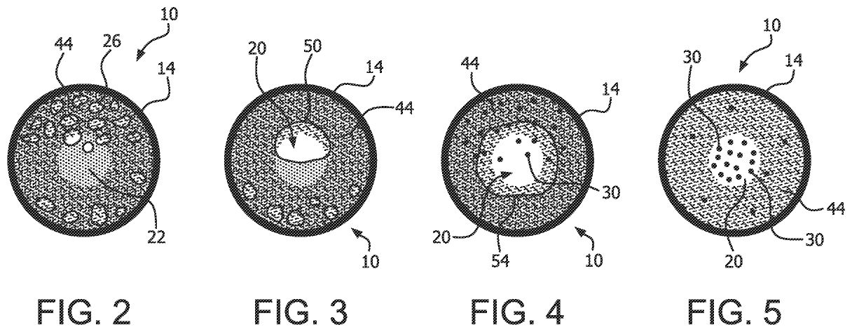

As shown in FIG. 2, the liquid 22 initially fills the tube 10 and flows through the open cells of the foam 44 and gains heat from the tube wall 14 and from contact with the foam 44. Some of the liquid reaches its boiling point and then transitions to small bubbles 26. As liquid 22 traverses the tube 10 more heat is absorbed by the liquid which then forms larger bubbles 50 as shown in FIG. 3. The vapor space progressively gets larger as more of the liquid boils in the flow direction of the liquid, as shown by at annular flow region liquid/gas interface 54 in FIG. 4. The vapor phase indicated by vapor particles 30 continues to expand and begins to fill the open center 20. Finally, in the last phase shown in FIG. 5 all liquid has turned to gas as shown by particles vapor phase particles 30.

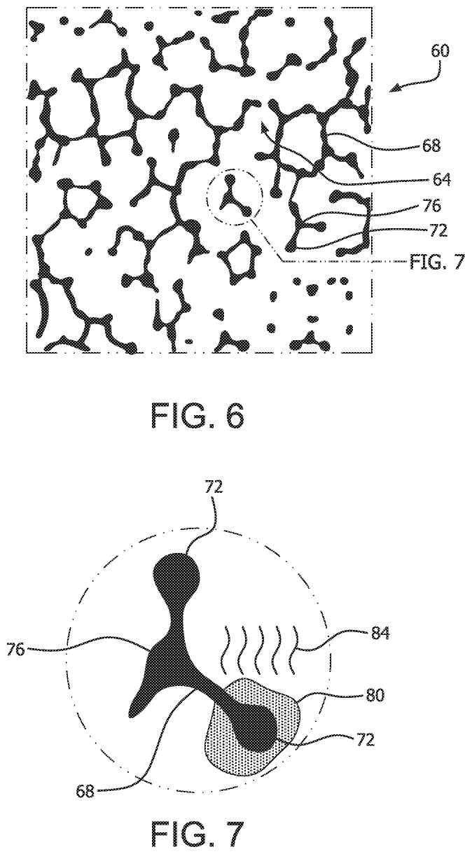

There is shown in FIGS. 6-7 a schematic diagram of a suitable open cell foam 60 for the heat exchanger of the invention. The foam 60 is comprised of cells 64 made up of cell walls 68 and nodules or seams 76 joining the cell walls 68. Cell wall terminations 72 form pore openings. The cell wall seams 76 and terminations 72 are provide nucleation sites for the water 80 which is heated and transitions into vapor 84.

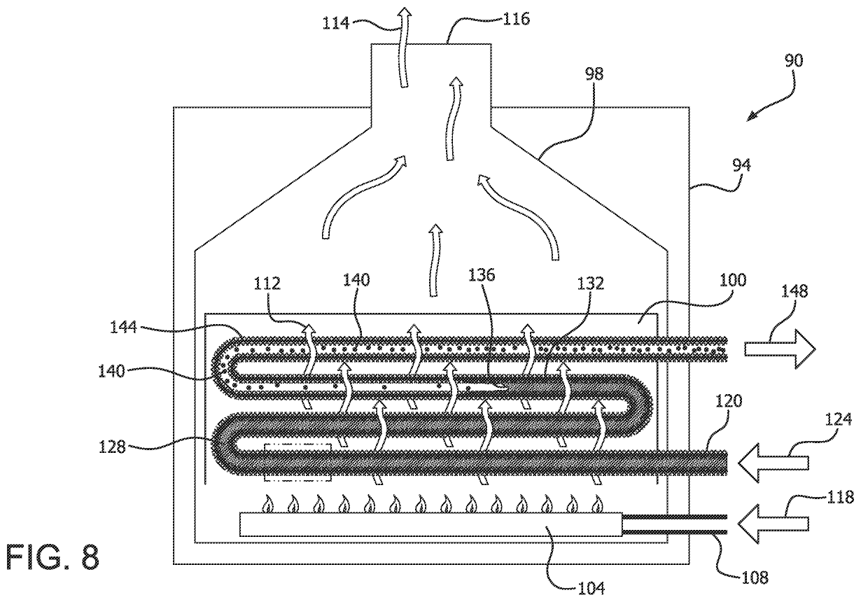

There is shown in FIG. 8 a flow boiler 90 according to the invention. The flow boiler 90 includes a housing 94 which can contain a heat exchange chamber 100 and exhaust flue 98. A burner 104 is provided and receives fuel 118 through a fuel inlet 108. Heated fluid such as air generated by the burner 104 rises through the heat exchange chamber 100 as shown by arrows 112 and escapes as exhaust gas 114 through exhaust opening 116 of the exhaust flue 98.

A heat exchange tube 120 according to the invention is provided within the heat exchange chamber 100. The heat exchange tube 120 receives liquid such as water 124. In an initial part of the tube 128 liquid is absorbing heat but does it has not yet transitioned to the vapor phase. As the liquid traverses the heat exchange tube 120 the liquid begins to vaporize and in a region 132 attains at an annular flow regime 136. As the liquid continues to traverse the tube 120 it transitions to a region 144 where the liquid has completely transitioned to the vapor phase 140. The vapor 140 leaves the heat exchange tube 120 as shown by arrow 148.

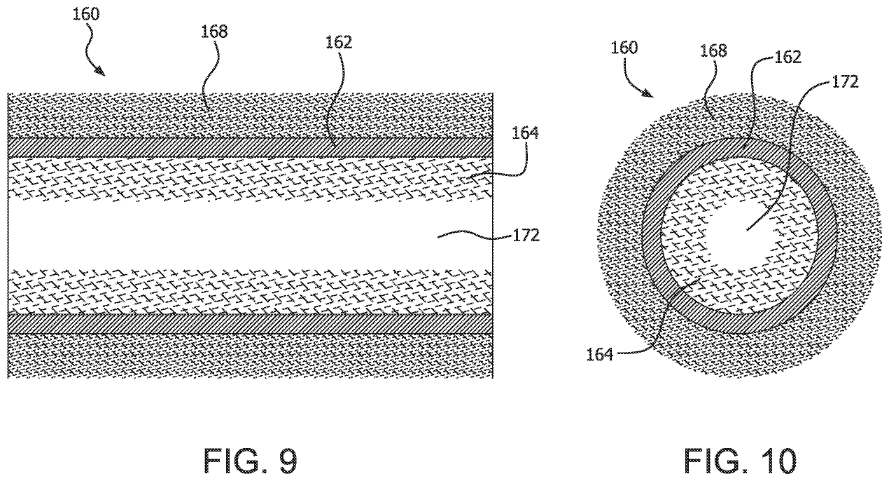

As shown in FIGS. 9-10, the heat exchange tube 160 can include a tube wall 162 having an open cell foam layer 164 on an inside portion of the tube 162 and an open cell foam layer 168 on an outside portion of the heat exchange tube 162. The foam layer 164 is tubular-shaped and defines an open center 172. The open cell foam layer 164 and the open cell foam layer 168 can have the same or different dimensional and material characteristics.

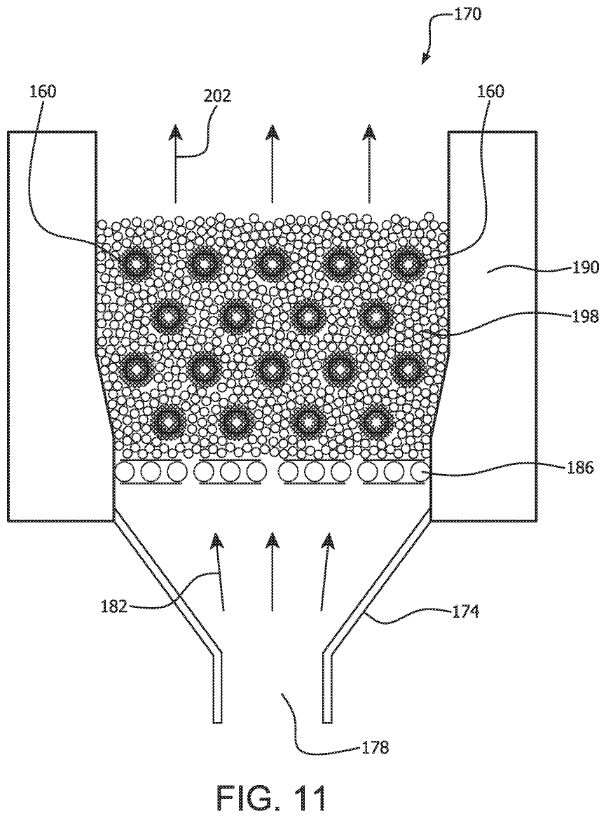

There is shown in FIG. 11 a volumetric matrix combustion (VMC) apparatus 170 in which the heat exchange tubes 160 of FIGS. 9-10 are provided. The VMC apparatus 170 has an inlet portion 174 with an opening 178 for the introduction of hot gas 182 from a suitable source. The gas 182 can traverse a grid 186 forming the bottom of an insulated housing 190 which together holds a matrix material 198 in which the heat exchange tubes 160 traverses. The matrix material can be any material compatible for high temperature. This includes ceramics and ceramics composite, cermet and high entropy (temperature) metal alloys. The hot gas passes through the matrix material 198 and transfers heat to the heat exchange tubes 160 and to fluid flowing through the heat exchange tubes 160. Gas exhaust 202 leaves through the top of the apparatus 170.

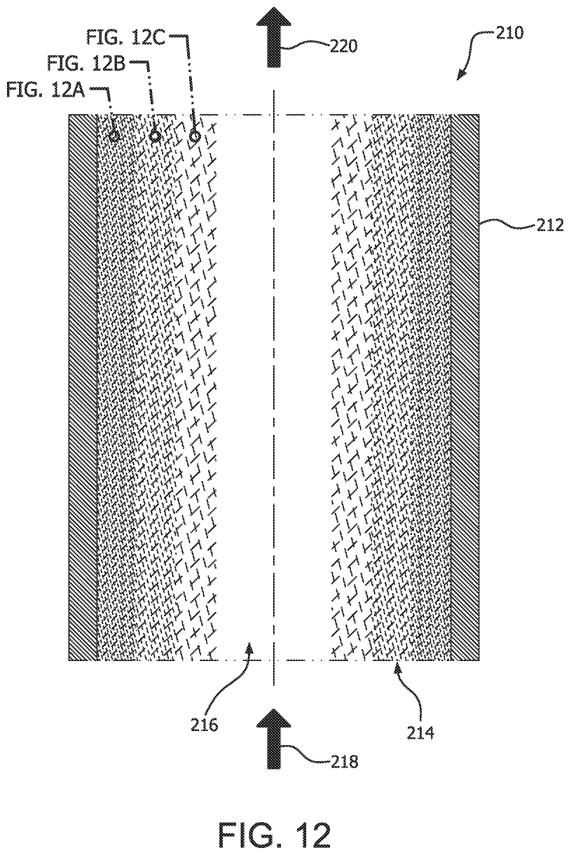

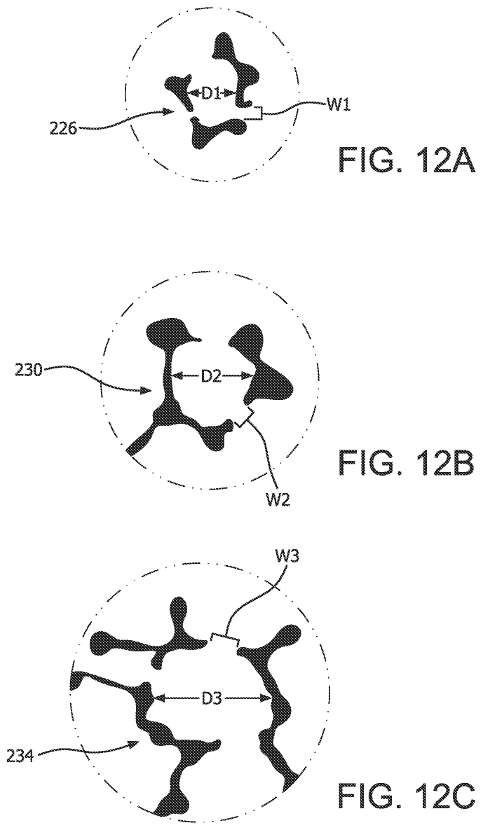

There is shown in FIG. 12 a heat exchanger apparatus 210 with a heat exchange tube 212 having an open cell foam inner layer 214. The open cell foam layer 214 is tubular shaped with an open center 216. Liquid flows into the inlet in the direction 218 and exits in the direction 220. As shown in FIG. 12A, the cells 226 nearest tube wall 212 have a cell size D1 and pore size W1. As shown in FIG. 12B, cells 230 that are radially inward from the cells 226 have a larger cell size D2 and pore size W2. As shown in FIG. 12C, cells 234 that are nearest the center 216 have a cell size D3 and a pore size W3 that is larger than that of either of the cells 230 and the cells 226.

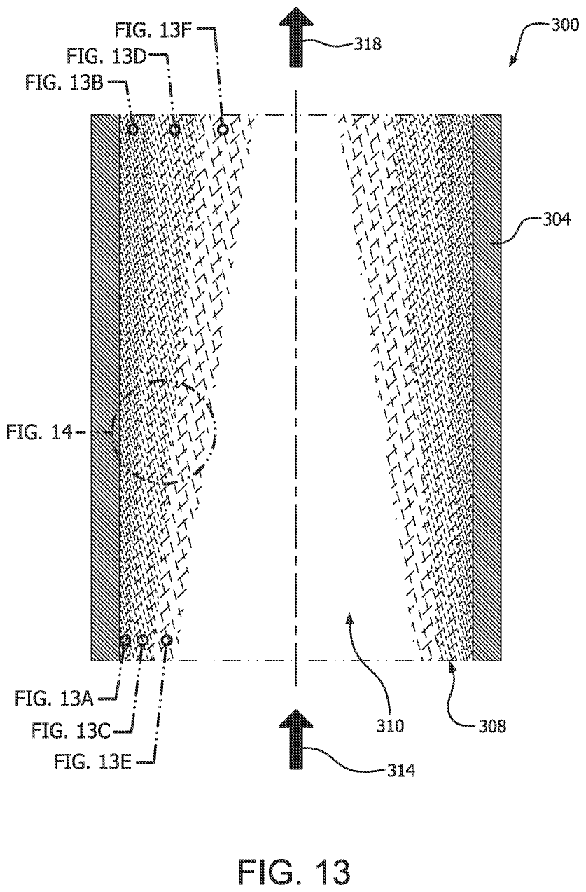

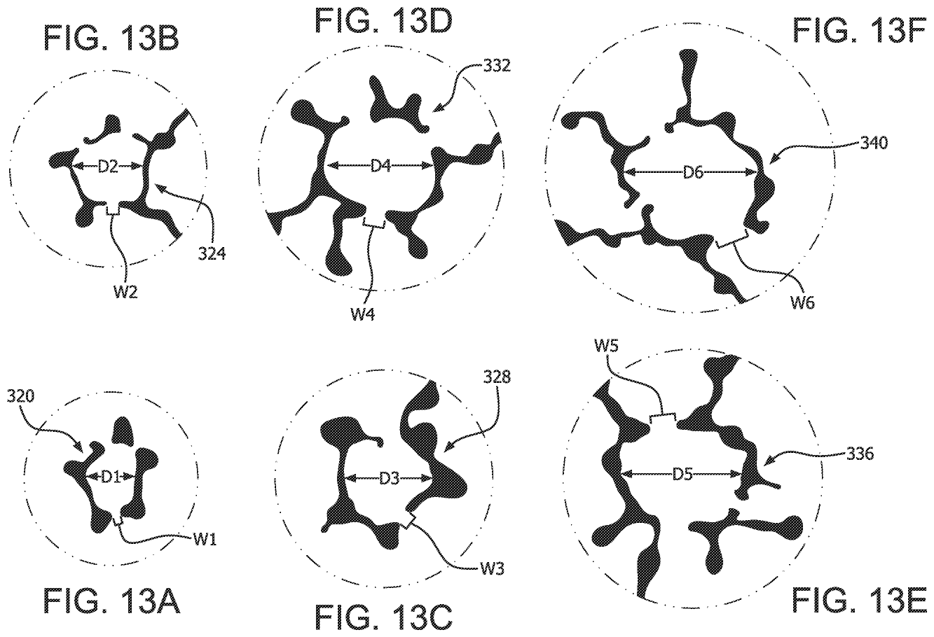

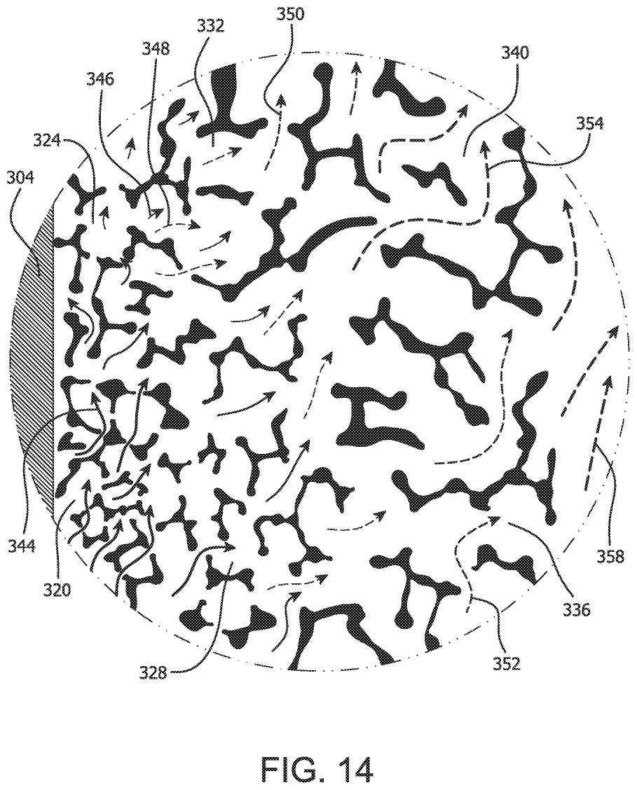

The cell size and corresponding portion size can be varied not only in the radial direction but also in the axial direction. There is shown in FIG. 13 a heat exchange apparatus 300 having a tube 304 and a dual gradient foam layer 308 that is tubular shaper with an open center 310. Liquid enters as shown by arrow 314 and exits as a vapor 318. As shown in FIG. 13A the cells 320 that are upstream and near the wall 304 have a cell size D1 and a pore size W1. As shown in FIG. 13B, a cell 324 in the same radial position but downstream axially from the cell 320 can have a cell size D2 and a pore size W2 that is greater than the cell size D1 and pore size W1 of the cell 320. As shown in FIG. 13C, the upstream cell 328 which is radially inward from the upstream cell 320 has a cell size D3 and a pore size W3 that is greater than the cell size D1 and the pore size W1 of the radially outward upstream cell 320 that is nearest the tube wall 304. As shown in FIG. 13D, a cell 332 that is downstream of the cell 328 but in the same radial position has a cell size D4 and a pore size W4 that is greater than the cell size D3 and the pore size W3 of the upstream cell 328. The downstream cell 332 has a cell size D4 and a pore size W4 that is also greater than the cell size D2 and pore size W2 of the downstream cell 324 that is radially outward and closest to the tube wall 304. There is shown in FIG. 13E an upstream cell 336 that is radially innermost and has a cell size D5 and a pore size W5 that is greater than the cell size D3 and the pore size W3 of the upstream cell 328 that is radially outward from the cell 336. The cell size D5 and the pore size W5 of the upstream cell 336 is smaller than the cell size DG and the pore size W6 of a downstream cell 340 that is downstream of the upstream cell 336 but in the same radially innermost position. The foam layer 308 thereby exhibits a cell size and a pore size gradient in both the radial and axial directions. The thickness of the layer 308 is also seen to increase from the upstream to the downstream location.

There is shown in FIG. 18 a schematic representation of fluid flow through the heat exchange apparatus wherein water flow symbolized by solid arrow 344 flows through upstream cells 320 close to tube wall 304. The liquid water is wicked through the open cell foam through for example downstream cells 324. As the water moves axially down the tube it is heated and vaporizes. Flow of this vapor, symbolized by dashed arrows, is both radially inward and axial. Liquid 346 and vapor 348 move axially through the cells 332 and vapor 350 and vapor 354 are generated and move through radially inward downstream cells 340 which are large enough to accommodate the volume of gas vapor that is moving through the foam at this point. Vapor 358 moves through the center 310. The dual gradient thereby wicks liquid near the wall 304, while increasing the cell and pore size in the radial inward and downstream directions to accommodate the increasing volume of the vapor.

The invention as shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed in accordance with the spirit of the invention, and such changes, alternations and modifications as would occur to those skilled in the art are considered to be within the scope of this invention as broadly defined in the appended claims. In addition, it is to be understood that the phraseology and terminology employed herein are for the purpose of description and should not be regarded as limiting.

We claim:

1. A heat exchanger apparatus, comprising:
a tube having a wall with an inner surface and an outer surface, the tube configured to receive heat exchange fluid at one end, and output, when heated through the wall, vapor of the heat exchange fluid at the opposing end; and,
a first layer of thermally conductive porous material disposed on the inner surface.

2. The heat exchanger of claim 1, wherein the heat exchange fluid comprises water, and the vapor of the heat exchange fluid is steam.

3. The heat exchanger of claim 1, wherein the thermally conductive porous material comprises at least one selected from the group consisting of Cu, Al, or Fe, and alloys thereof.

4. The heat exchanger of claim 1, wherein the thermally conductive porous material comprises metal foams.

5. The heat exchanger of claim 4, wherein the metal foams comprise open cells.

6. The heat exchanger of claim 5, wherein the open cells have pore openings between cells, the pore size of the pore openings being from 0.1 μm to 10 mm.

7. The heat exchanger of claim 5, wherein the metal foam has a porosity in a range of 40%-95%.

8. The heat exchanger of claim 5, wherein the metal foam has a pore density in a range of 5-100 pores per inch (PPI).

9. The heat exchanger of claim 5, wherein the open cells have a cell diameter of from 1 μm to 10 mm.

10. The heat exchanger of claim 5, wherein the cell diameter of the open cells increases from a first size proximate to the wall to a second size greater than the first size distal to the wall.

11. The heat exchanger of claim 5, wherein the tube has a flow direction, and wherein the cell diameter of the open cells increases from a first size at an upstream location relative to the flow direction to a second size greater than the first size downstream relative to the flow direction.

12. The heat exchanger of claim 5, wherein the tube has a flow direction, and wherein metal foam has a layer thickness, and wherein the layer thickness the metal foam increases from a first size at an upstream location relative to the flow direction to a second size greater than the first size downstream relative to the flow direction.

13. The heat exchanger of claim 1, wherein the first layer of thermally conductive porous material has a thickness in a range of 0.5%-50% of the inner radius of the tube.

14. The heat exchanger of claim 1, further comprising a second layer of thermally conductive porous metal on the outer surface.

15. The heat exchanger of claim 14, wherein the second layer of thermally conductive porous material has a thickness in a range of 10%-100% of the outer radius of the tube or 10%-50% of the distance between adjacent portions of the tube, when the tube is configured to have one or more bends.

16. The heat exchanger of claim 14, further comprising a ceramic coating on at least one selected from the group consisting of the first layer of thermally conductive porous material and the second layer of thermally conductive porous material.

17. The heat exchanger of claim 16, wherein the ceramic coating comprises SiC or SiN.

18. Heating equipment, comprising:
a burner;
a heat exchanger comprising a tube having a wall with an inner surface and an outer surface, the tube configured to receive heat exchange fluid at one end, and output, when heated through the wall, vapor of the heat exchange fluid at the opposing end, and a first layer of thermally conductive porous material disposed on the inner surface;
wherein the tube of the heat exchanger is disposed adjacent to the burner, so the heat exchange fluid is heated through the wall by the burner during operation of the heating equipment.

19. The heating equipment of claim 18, where the heat exchanger is configured as a boiler or an evaporator.

20. The heating equipment of claim 18, wherein the heat exchanger is a flow boiler.

21. The heating equipment of claim 18, where the burner is configured to be fueled with natural gas.

22. A heat exchanger, comprising:
a tube having a wall with an inner surface and an outer surface, the tube configured to receive heat exchange fluid at one end, and output, when heated through the wall, vapor of the heat exchange fluid at the opposing end; and,
a first layer of thermally conductive porous metal foam disposed on the inner surface; and
a second layer of the thermally conductive porous metal foam disposed on the outer surface.

23. A heat exchanger, comprising:
a heat exchange wall with a first surface and a second surface for separating a first heat exchange fluid from a second heat exchange fluid, the first fluid moving in a flow direction relative to the first surface of the wall;
a first layer of thermally conductive porous open cell metal foam disposed on the first surface, the open cells of the metal foam having a cell diameter;
wherein the cell diameter of the open cells increases from a first size proximate to the wall to a second size greater than the first size distal to the wall, and wherein the cell diameter of the open cells increases from a first size at an upstream location relative to the flow direction to a second size greater than the first size downstream relative to the flow direction;
wherein the first fluid flows through the open cells of the metal foam in the flow direction, and changes state from a liquid to a gas, and wherein the gas passes through cells having a greater cell diameter than the cell diameter of the cells through which the liquid flows.

24. A method of heating a fluid, comprising the steps of:
providing a heat exchange tube, comprising a heat exchange wall with a first surface and a second surface for separating a first heat exchange fluid from a second heat exchange fluid, the first fluid moving in a flow direction relative to the first surface of the wall, with a first layer of thermally conductive porous material disposed on the first surface; and,
flowing the first fluid through the thermally conductive porous material in the flow direction, wherein the first heat exchange fluid exchanges heat with the second heat exchange fluid.

25. The method of claim 24, wherein the porous material comprises open cells having a cell diameter, and wherein the cell diameter of the open cells increases from a first size proximate to the wall to a second size greater than the first size distal to the wall.

26. The method of claim 24, wherein porous material comprises open cells having a cell diameter, and the cell diameter of the open cells increases from a first size at an upstream location relative to the flow direction to a second size greater than the first size downstream relative to the flow direction.
